(19) United States
(12) Patent Application Publication
(10) Pub. No.: US 2011/0081146 A1
(43) Pub. Date: Apr. 7, 2011

(54) OPTICAL MONITOR DEVICE

(75) Inventors: Ichiro NAKAJIMA, Kawasaki (JP); Hideaki Sugiya, Kawasaki (JP)

(73) Assignee: FUJITSU LIMITED, Kawasaki (JP)

(21) Appl. No.: 12/897,274

(22) Filed: Oct. 4, 2010

(30) Foreign Application Priority Data
Oct. 6, 2009 (JP) 2009-232539

(51) Int. Cl. H04J 14/00

(52) U.S. Cl. 398/48; 398/45

(57) ABSTRACT

An optical monitor device includes a band pass filter configured to transmit a light of a band of a first input light, an optical switch configured to select between a second input light and the first input light transmitted through the band pass filter based on a switch signal, and output the selected light, a tunable filter configured to input a selected light from the optical switch and to transmit a specified wavelength based on a drive signal, a photodetector configured to output an electric signal according to a power level of transmitted light from the tunable filter, and a control unit configured to output the switch signal and the drive signal based on the electric signal.

### CROSS-REFERENCE TO RELATED APPLICATIONS

This application is based upon and claims the benefit of priority from the prior Japanese Patent Application No. 2009-232539 filed on Oct. 6, 2009, the entire contents of which are incorporated herein by reference.

### FIELD

The embodiments discussed herein are related to a device that monitors a light transmitted in a Wavelength Division Multiplexing (WDM) optical transmission system.

### BACKGROUND

In a WDM optical transmission system, an Optical Add-Drop Multiplexer (OADM), which may select “Through,” “Add,” or “Drop” by a wavelength unit of light, is provided in a node in a network, a ring network of Point-to-Point, or a mesh network. To realize long-distance transmission, the OADM may monitor a WDM light output from the device and perform level adjustment of each wavelength included in the WDM light.

There are two types of methods for monitoring the WDM light. One is a method for monitoring by spatially demultiplexing the WDM light into lights (channels) of each wavelength. The other is a method for monitoring by transmitting the WDM light through a tunable filter and temporally demultiplexing a transmission wavelength thereof. The former method for spatially demultiplexing is performed by using an optical branching device such as an optical diffraction grating and a photodiode array for light reception and desires a photodiode for the number of wavelengths included in the WDM light. That is, the former method is disadvantageous in cost reduction. The latter method for temporally demultiplexing with a tunable filter has a structure that is disclosed in FIG. 6 of Japanese Laid-open Patent Publication No. 2006-340208, for example, and desires one photodiode for light reception. Compared to the former method, the latter method is advantageous in cost reduction.

FIG. 6 illustrates an optical monitor device using a tunable filter. As illustrated in FIG. 6, a monitor device monitors a WDM light to be output in an OADM 1 provided in a node in the optical transmission system. In the OADM 1, the WDM light input through an optical amplifier A1 as a preamplifier is branched by an optical branching device 1a and then is input into a first optical demultiplexer 1b and a second optical demultiplexer 1c. The first optical demultiplexer 1b demultiplexes an input light into lights for each wavelength and outputs each light to a client device (not illustrated). The second optical demultiplexer 1c demultiplexes an input light into lights for each wavelength and outputs each light to an optical switch 1d. The optical switch 1d, which is provided for each wavelength, selects “Through” or “Add” of a signal light in the node for each wavelength. The output light of the optical switch 1d is level-adjusted by a Variable Optical Attenuator (VOA) 1e provided for each wavelength and is then multiplexed by an optical multiplexer 1f. For the WDM light that is multiplexed and output by the optical multiplexer 1f, part of the light is branched as a monitor light by an optical branching device C1, and the rest of the light is transmitted to an optical transmission path through an optical amplifier A2 as a post amplifier.

The monitor light branched by the optical branching device C1 is input into an optical monitor device 2. In the optical monitor device 2, the monitor light is input into a tunable filter (TF) 2a, and a light in a prescribed wavelength is mainly transmitted through the tunable filter 2a. The light transmitted through the tunable filter 2a is photoelectrically converted by a photodetector 2b such as a photodiode (PD), and an electric signal corresponding to received light power is input into a control unit 2c. Based on the output signal from the photodetector element 2b, the control unit 2c determines power corresponding to the light of each wavelength of the WDM light output from the OADM 1, and outputs the result to a VOA control device 3 of the VOA 1e. According to the result, the VOA control device 3 controls an attenuating amount of the VOA 1e so that output power of the light of each wavelength reaches a target level.

To vary the transmission wavelength of the tunable filter 2a, the control unit 2c of the optical monitor device 2 performs sweep of a drive signal for driving the tunable filter 2a or a drive voltage in this case in a prescribed range. The tunable filter 2a makes the transparent wavelength variable by mechanically moving, by an actuator or the like, a thin film (a dielectric multilayered film) whose transmission characteristics vary according to an input position of the light. As a result, according to the sweep of the drive voltage by the actuator or the like, the wavelength of the monitor light transmitting through the tunable filter 2a varies as time goes by. Therefore, power of the light of each wavelength included in the monitor light is monitored (detected) by the optical monitor device 2. According to a result of the monitoring, level adjustment of the output signal light is performed by the VOA 1e.

The tunable filter 2a provided in the optical monitor device 2 has a temperature dependence in which the transmission wavelength characteristics vary according to temperature variation. Therefore, the tunable filter 2a is provided with a temperature sensor (not illustrated) that measures a temperature. The control unit 2c performs calibration of the drive voltage according to a temperature value measured by the temperature sensor. Calibration data to be used for this calibration stored in the control unit 2c is illustrated inside a dotted line in FIG. 6.

The transmission reference wavelength of the light of the shortest wavelength side transmitting through the tunable filter 2a is indicated as λref1, and the transmission reference wavelength of the light of the longest wavelength side thereof is indicated as λref2. Firstly, the light of the transmission reference wavelength λref1 is generated by using a light source with high wavelength accuracy, and the light of the above-described wavelength λref1 is input into the tunable filter 2a in the lowest temperature TL in an operable temperature range. After that, the drive voltage of the tunable filter 2a gradually rises, and the drive voltage obtained when the transmission light of a prescribed level is detected is indicated as a reference value Vref1 in the lowest temperature TL. Similarly, the light of the transmission reference wavelength λref2 is generated by using the light source with the high wavelength accuracy, and the similar measurement is performed. The drive voltage obtained when the transmission light of the prescribed level is detected in the lowest temperature TL is indicated as a reference value Vref2 at which the drive is ended in the lowest temperature TL. When the references values Vref1 and Vref2 are obtained, the drive voltage between the reference values Vref1 and Vref2 may be interpolated.

The light of the transmission reference wavelength λref1 is generated by using the above-described light source, and the light of the transmission reference wavelength λref1 is input into the tunable filter 2a in the highest temperature TH in the operable temperature range. The drive voltage of the tunable filter 2a gradually rises, and the drive voltage obtained when the transmission light of the prescribed level is detected is indicated as the reference value Vref1 at which the drive is started in the highest temperature TL. After that, the light of the transmission reference wavelength λref2 is generated by using the above-described light source, and the similar measurement is performed. The drive voltage obtained when the transmission light of the prescribed level is detected in the highest temperature TH is indicated as the reference value Vref2 at which the drive is ended in the highest temperature TH. Also in this case, when the reference values Vref1 and Vref2 are obtained, the drive voltage between the reference values Vref1 and Vref2 may be interpolated.

For example, a temperature between the lowest temperature TL and the highest temperature TH may be interpolated every time the above-described measurement is performed by one degree or may be interpolated by calculation according to the characteristics of the tunable filter 2a. By the above-described calibration, the calibration data illustrated in the diagrams is stored in the storage area of the control unit 2c at the time of shipment of the optical monitor device 2. Therefore, based on the temperature value obtained from the temperature sensor of the tunable filter 2a, the control unit 2c reads out the reference values Vref1 and Vref2 corresponding to the current temperature of the tunable filter 2a, sets the reference value Vref1 as a reference voltage at which the drive of the tunable filter 2a is started and sets the reference value Vref2 as a reference voltage at which the drive of the tunable filter 2a is ended. Accordingly, since the sweep of the drive voltage is performed from the reference value Vref1 to the reference value Vref2, the tunable filter 2a is driven with an appropriate drive voltage according to a temperature.

If the voltage range (a voltage difference between a start voltage and an end voltage) for the sweep of the drive voltage is obtained according to the characteristics of the tunable filter 2a, either Vref1 at the driving start or Vref2 at the driving end is generally obtained.

### SUMMARY

According to an aspect of the invention, an optical monitor device includes: a band pass filter configured to transmit a light of a band of a first input light, an optical switch configured to select between a second input light and the first input light transmitted through the band pass filter based on a switch signal, and output the selected light, a tunable filter configured to input a selected light from the optical switch and to transmit a specified wavelength based on a drive signal, a photodetector configured to output an electric signal according to a power level of a transmitted light from the tunable filter, and a control unit configured to output the switch signal and the drive signal based on the electric signal.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1A is an example of an optical transmission system using an optical monitor device,

FIG. 1B is another example of the optical transmission system using an optical monitor device,

FIG. 2A is a block diagram illustrating an optical monitor device according to a first embodiment,

FIG. 2B is an explanation diagram of the first embodiment using an optical spectrum,

FIG. 3A is an example of an operation timing of an optical switch,

FIG. 3B is an example of a transmission band of a band pass filter,

FIG. 4A is a block diagram illustrating an optical monitor device according to a second embodiment,

FIG. 4B is an explanation diagram of the second embodiment using an optical spectrum,

FIG. 5A is a block diagram illustrating an optical monitor device according to a third embodiment,

FIG. 5B is an explanation diagram of the third embodiment using an optical spectrum, and

FIG. 6 is a block diagram illustrating a conventional optical monitor device.

### DESCRIPTION OF EMBODIMENT(S)

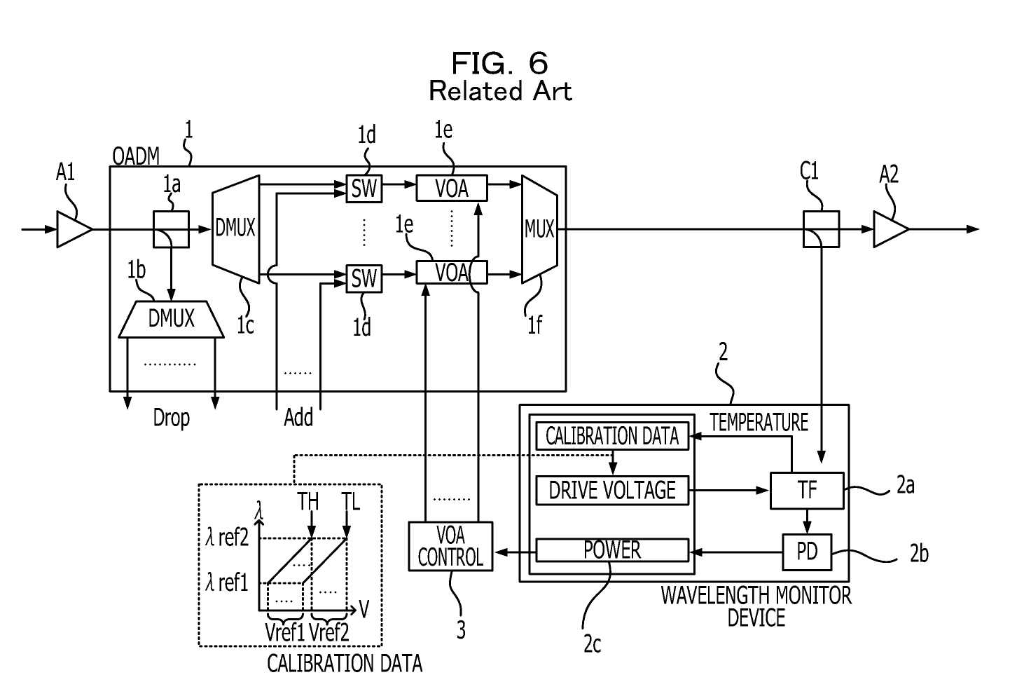

The above-described optical monitor device that monitors a light of each wavelength to be multiplexed with a WDM light is desired to have high accuracy of wavelength because a signal light quality depends on the wavelength accuracy. For example, if deviation of a wavelength of a signal light source occurs, a spectrum waveform of the signal light whose wavelength is deviated is deformed by filter characteristics of the device (the optical demultiplexer is or the optical multiplexer if in a configuration example in FIG. 6) used in demultiplexion or multiplexion of the WDM light. To avoid the above-described situation, the optical monitor device monitors a wavelength of each signal light included in the WDM light at a high accuracy and generates an alarm if deviation that is equal to or greater than a prescribed value is detected. Therefore, a temperature sensor and calibration data are preferably embedded to compensate the temperature dependence of the optical monitor device as described above. However, the tunable filter with a temperature sensor is expensive, so that cost reduction of the optical monitor device is not achieved.

Instead of embedding the temperature sensor and the calibration data, a temperature control circuit may be provided to maintain a temperature of the tunable filter. However, there are problems such as increase of the cost of the temperature control circuit and the consumption power or expansion of the size of the device.

In the tunable filter using a mechanical unit such as an actuator, deviation may occur in the reference value of the drive signal corresponding to a reference wavelength due to errors of chemical components caused by aged deterioration. Moreover, the optical characteristics of the thin film may be varied due to the aged deterioration. As described above, the calibration data is stored regarding to a temperature by the calibration procedure before shipment, so that errors caused by the aged deterioration are difficult to be corrected.

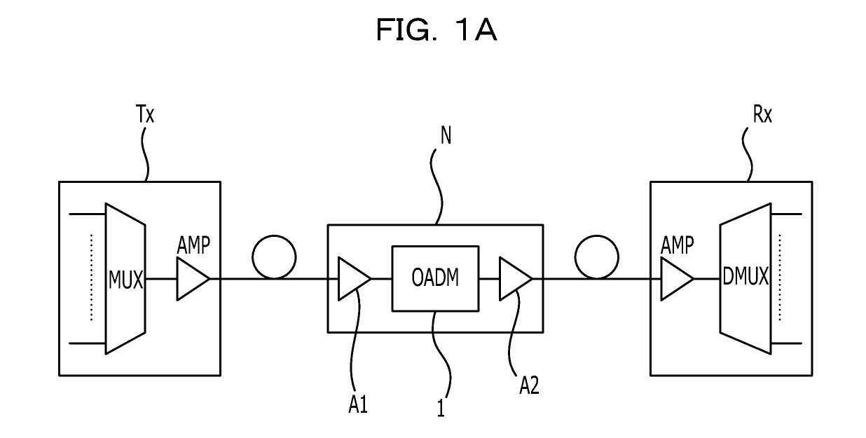

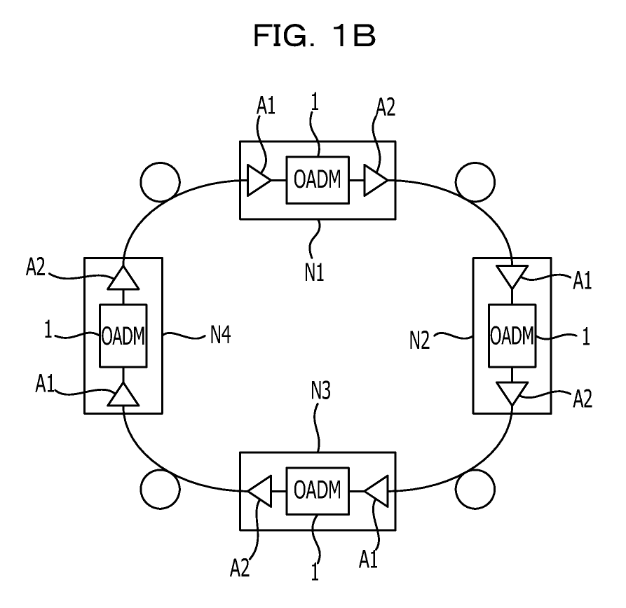

Embodiments will be described below. FIGS. 1A and 1B illustrate an example of a WDM method transmission system using an optical monitor device. FIG. 1A illustrates an optical transmission system of one-to-one network in which a terminal device Tx of a transmission side is coupled to a terminal device Rx of a reception side through an optical transmission path. A node N provided in the middle of the optical transmission path includes the OADM 1, and the optical amplifiers A1 and A2 located in front of and behind the OADM 1. FIG. 1B illustrates an optical transmission system of a ring-shaped network. This optical transmission system includes a plurality of nodes N1 to N4 that are coupled in a ring shape through an optical transmission path, and each of the nodes includes the OADM 1, and the optical amplifiers A1 and A2 located in front of and behind the OADM 1. The optical monitor device of the embodiments described below is not limited to the examples of the above-described systems. The optical monitor device is generally applicable to devices that monitor the WDM light for each wavelength. For example, the optical monitor device may be used in terminal apparatuses Tx and Rx illustrated in FIG. 1A or other relay devices other than the OADM.

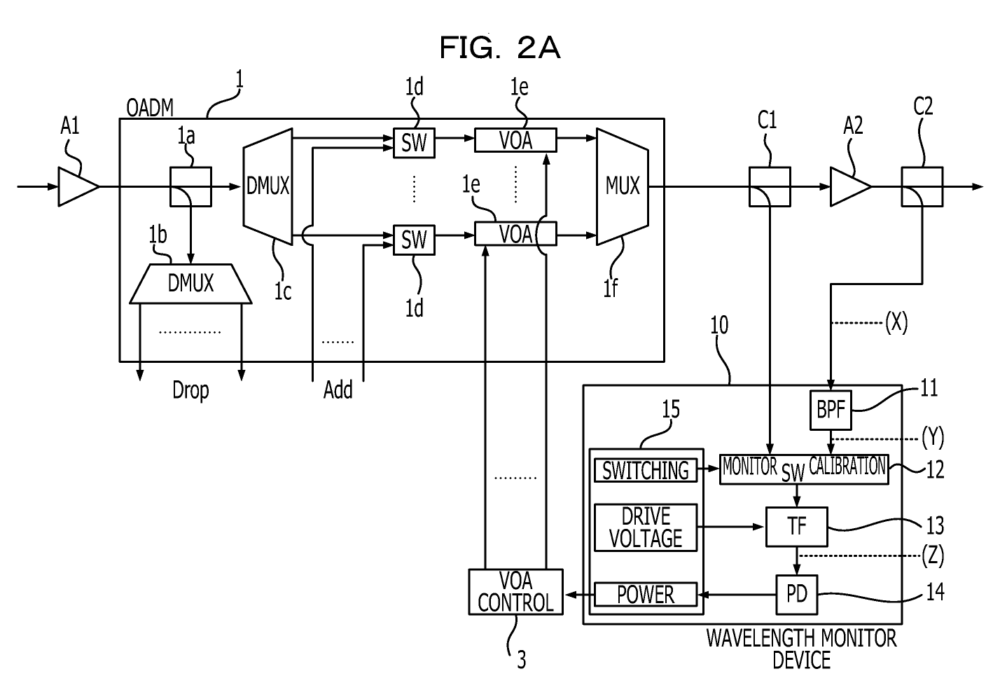

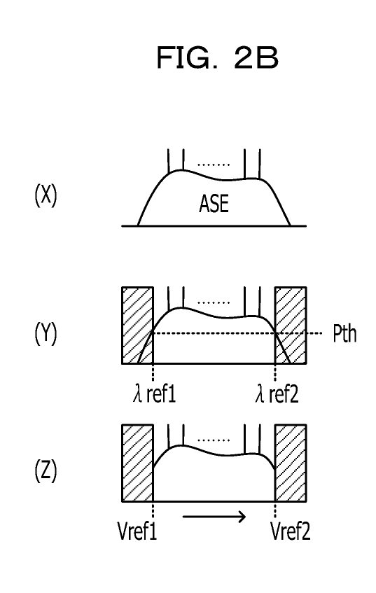

FIGS. 2A and 2B illustrate a first embodiment of an optical monitor device 10 that is located with respect to the OADM 1 illustrated in FIGS. 1A and 1B and monitors a WDM light to be output. As illustrated in FIG. 2A, in the OADM 1, the WDM light input through the optical amplifier A1 as a preamplifier is branched by the optical branching device 1a, and the branched lights are input into a first optical demultiplexer 1b and a second optical demultiplexer 1c, respectively. The first optical demultiplexer 1b demultiplexes the input light into lights for each wavelength and outputs each light to a client device (not illustrated). The second optical demultiplexer 1c demultiplexes the input light into lights for each wavelength and outputs each light to the optical switch 1d. The optical switch 1d, which is provided for each wavelength, selects and outputs either the light to be transmitted by the node or the light to be inserted by the node. For the output light of the optical switch 1d, the light level (light power) thereof is adjusted by a VOA 1e provided for each wavelength and is then multiplexed by the optical multiplexer 1f. Part of the WDM light multiplexed and output by the optical multiplexer 1f is branched by the optical branching device C1 (the first optical branching device) for monitoring. The other light branched by the optical branching device C1 is transmitted to the optical transmission path through the optical amplifier A2 as a post-amplifier. The light (the WDM light to be monitored) for monitoring that is branched by the optical branching device C1 is input into the optical monitor device 10.

The optical monitor device 10 includes a band pass filter (BPF) 11, an optical switch (SW) 12, a tunable filter (TF) 13, a photodetector (PD) 14, and a control unit 15.

By an optical branching device C2 (a second optical branching device) provided in the optical transmission path, part of the WDM light output from the optical amplifier A2 is branched and input into the band pass filter 11. FIG. 2B is an explanation diagram of a first embodiment using an optical spectrum. As illustrated in a waveform (X) in FIG. 2B, the WDM light to be input into the band pass filter 11 includes an Amplified Spontaneous Emission (ASE) light that is generated in an optical amplifying process of the optical amplifier A2. The band pass filter 11, which is an optical filter of a fixed band formed by using, for example, a dielectric multilayered film filter, has a characteristic that temperature dependence is low and the aged deterioration is small. In case of FIG. 2B, the transmission band of the band pass filter 11 is designed to be narrower than the band of the ASE light included in the input WDM light and to be wider than the signal band. Therefore, as illustrated in a waveform (Y) of FIG. 2B, the spectrum of the WDM light that transmits through the band pass filter 11 is formed to be a waveform with a sudden rise and a sudden fall accompanied by an increase of the transverse axis (wavelength) by cutting off both end areas of the ASE light band. In the present embodiment, the wavelength on the rising edge of the transmission band is indicated as a reference wavelength λref1 and the wavelength on the falling edge of the transmission band is indicated as a reference wavelength λref2. A light (a reference light) with a band between the reference wavelength λref1 of the short wavelength side and the reference wavelength λref2 of the long wavelength side is output from the band pass filter 11.

In FIG. 2A, in the optical switch 12, the light (the monitor light) obtained by branching the WDM light that is output from the OADM 1 and input into the optical amplifier A2 by the optical branching device C1 is input into a terminal of the monitor side, and the light (the reference light) output from the band pass filter 11 is input into a terminal of the calibration side. Accordingly, if the optical switch 12 is switched to the monitor side, the monitor light is output. If the optical switch 12 is switched to the calibration side, the reference light is output.

The tunable filter 13 according to the present embodiment has a configuration in which the transmission wavelength may be varied according to the drive voltage provided as an operation signal, so that the transmission wavelength varies according to the sweep of the drive voltage. When the optical switch 12 is switched to the monitor side, the monitor light is input into the tunable filter 13. Thus, when the transmission wavelength varies from the reference wavelength λref1 of the short wavelength side to the reference wavelength λref2 of the long wavelength side by the sweep of the drive voltage, the signal light of each wavelength that is multiplexed with the monitor light is temporally demultiplexed and output. On the other hand, when the optical switch 12 is switched to the calibration side, the reference light transmitted through the band pass filter 11 is input into the tunable filter 13, and the reference light is sequentially output according to the sweep of the drive voltage as illustrated in a waveform (Z) in FIG. 2B.

The photodetector 14, which includes, for example, a photodiode, receives and photoelectrically converts the transmission light of the tunable filter 13, and then outputs an electric signal indicating the light power. The control unit 15 outputs a signal that controls the switch of the optical switch 12 and is driven by outputting the drive voltage to the tunable filter 13. Then the control unit 15 receives the output signal of the photodetector 14 and determines light power based on a value of the output signal.

If the control unit 15 switches the optical switch 12 to the monitor side and performs the sweep of the drive voltage of the tunable filter 13, the control unit 15 detects power corresponding to the signal light of each wavelength of the WDM light output from the OADM 1 by using the output signal from the photodetector 14. A signal indicating the detection result is transmitted from the control unit 15 to the VOA control device 3. Accordingly, the VOA control device 3 controls each of the VOAs 1e and performs level adjustment of the light for each wavelength to be multiplexed to the WDM light. On the other hand, when switching the optical switch 12 to the calibration side and sweeping the drive voltage of the tunable filter 13, the control unit 15 determines, by using the output from the photodetector 14, the power of the reference light output from the band pass filter 11, and, as illustrated in the waveforms (Y) and (Z) in FIG. 2B, stores, in the storage area, the drive voltage (that is, the output value of the drive signal) obtained when the light power rises and becomes equal to or greater than the threshold value as the reference value Vref1. After that, the control unit 15 stores, in the storage area, the drive voltage obtained when the light power detected by the photodetector 14 falls down and becomes equal to or lower than the threshold value Pth as the reference value Vref2.

Calibration of the reference values Vref 1 and Vref 2 performed by the control unit 15 will be described. For the light power within a light sensitivity of the photodetector 14, the threshold value Pth used to set the reference values Vref1 and Vref2 is set to a value that is lower than the level of the ASE light by some dBs. For example, for an Optical Signal-to-Noise Ratio (OSNR) of the WDM light that is relayed from the OADM 1, a range is determined according to a system design of the light transmission system. Thus, the threshold value Pth is determined to be set to a value that is lower than the minimum level of the ASE light in an acceptable range of the OSNR by 3 dBs. This value may be determined based on transmission band characteristics of the band pass filter 11.

In the initial setting before the optical transmission system service starts, the control unit 15 switches the optical switch 12 to the calibration side when the WDM light transmits as the reference light through the band pass filter 11. Accordingly, a WDM light (X) that includes the ASE light is input into the band pass filter 11. As described above, since the transmission band of the band pass filter 11 according to the present embodiment is narrower than the band of the ASE light and is wider than the signal band, the transmission light output from the band pass filter 11 suddenly rises in a short wavelength side and suddenly falls down in a long wavelength side as illustrated in the waveform (Y).

The control unit 15 starts the sweep of the drive voltage of the tunable filter 13 from the minimum value and detects the power of the reference light by monitoring the output signal of the photodetector 14. The control unit 15 stores the drive voltage, which is obtained when the detected light power rises and reaches a threshold value Pth, as a reference value Vref1 of the short wavelength side. While continuing the sweep of the drive voltage to the maximum value, the control unit 15 monitors the output signal of the photodetector 14 to detect the power of the reference light. The control unit 15 stores the drive voltage, which is obtained when the detected light power falls down and reaches the threshold value Pth, as a reference value Vref2 of the long wavelength side.

By performing the above-described calibration procedure by the control unit 15, the reference value Vref1 is initialized as a drive voltage with which the drive of the tunable filter 13 is started, and the reference value Vref2 is initialized as a drive voltage with which the drive of the tunable filter 13 is ended

When the service of the optical transmission system is started after the initial setting is finished, the control unit 15 performs monitoring of wavelength. That is, the control unit 15 switches the optical switch to the monitor side, so that the monitor light branched by the optical branching device C1 is input into the tunable filter 13. The control unit 15 performs the sweep of the drive voltage from the reference value Vref1 to the reference value Vref2, and detects the power by temporally demultiplexing the signal light of each wavelength included in the monitor light by the tunable filter 13. The detection result is transmitted to the VOA control device 3, and each of the VOAs 1e of the OADM 1 is controlled.

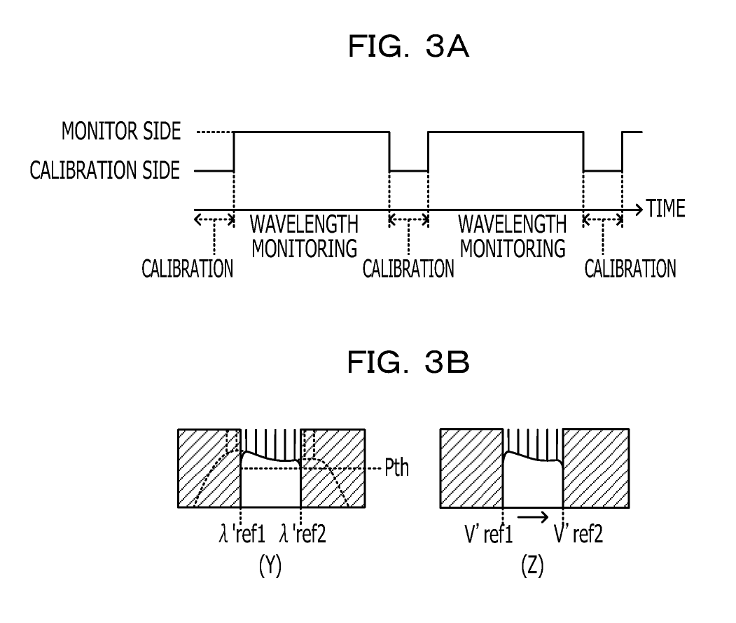

The control unit 15 in service performs calibration in service in a prescribed interval as illustrated in FIG. 3A, for example. That is, the control unit 15 measures a time by an internal timer or the like during the wavelength monitoring and switches the optical switch 12 to the calibration side from the monitor side at timing to perform the calibration so that the reference light from the band pass filter 11 is input into the tunable filter 13. As with the calibration in the initial setting, the control unit 15 starts the sweep of the drive voltage of the tunable filter 13 from the minimum value and updates the drive voltage, which is obtained when the light power detected by the output signal of the photodetector 14 rises and reaches the threshold value Pth, as the reference value Vref1 of the short wavelength side. While continuing the sweep of the drive voltage to the maximum value, the control unit 15 updates the drive voltage, which is obtained when the light power detected by an output signal of the photodetector 14 falls down and reaches the threshold value Pth, as the reference value Vref2 of the long wavelength side. The timing at which the control unit 15 performs the calibration in service may be appropriately set as timing based on a direction from an external unit and/or timing at which an ambient temperature varies.

By performing the calibration in service by the control unit 15, transmission characteristic variation of the tunable filter 13 according to temperature variation and/or the aged deterioration is compensated. That is, even when the transmission characteristics of the tunable filter 13 vary, the reference values Vref1 and Vref2 are sequentially updated according to the varied transmission characteristics by periodically performing the above-described calibration. Accordingly, the drive voltage provided by the control unit 15 is provided appropriately corresponding to the temperature of the tunable filter 13 and the aged deterioration. In this manner, the optical monitor device 10, which may compensate the temperature dependence and the aged deterioration of the tunable filter 13 by using a cheap band pass filter 11, is provided without embedding a temperature sensor and/or a temperature control circuit in the tunable filter 13.

FIG. 3B illustrates another example regarding to the transmission band of the band pass filter 11. FIG. 3B corresponds to the waveforms (Y) and (Z) of FIG. 2B. According to the example of FIG. 3B, wavelength accuracy of the tunable filter 13 with respect to the vicinity of a center wavelength of the WDM light may be improved. The transmission band of the band pass filter 11 in this example is narrower than the ASE light and than the signal band. As a result, compared to the case in FIG. 2B, the reference wavelengths λ′ref1 and λ′ref2 are closer to the center wavelength of the WDM light. For the light power within the light sensitivity of the photodetector 14, the threshold value Pth used to set the reference values Vref1 and Vref2 corresponding to the reference wavelengths λ′ref1 and λ′ref2 is set as a value that is lower than the level of the ASE light by some dBs.

If the WDM light that includes the ASE light as illustrated in the waveform (X) in FIG. 2B is input into the band pass filter 11 having the transmission band of FIG. 3B, the transmission light to be output from the band pass filter 11 is illustrated in the waveform (Y) in FIG. 3B. That is, the transmission light is wave-shaped with a sudden rise in the short wavelength side and a sudden fall in the long wavelength side in the vicinity of the center wavelength of the signal band. The control unit 15 sets the drive voltage, which is obtained when the light power detected by using the output signal of the photodetector 14 rises and reaches the threshold value Pth after sweeping the drive voltage of the tunable filter 13 from the minimum value, as a reference value V′ref1 of the short wavelength side (the waveform (Z) in FIG. 3B). The control unit 15 continues the sweep of the drive voltage to the maximum value and sets the drive voltage, which is obtained when the light power detected by using the output signal of the photodetector 14 falls down and reaches the threshold value Pth, as a reference value V′ref2 of the long wavelength side (the waveform (Z) in FIG. 3B).

The reference values V′ref1 and V′ref2 determined by the control unit 15 in the calibration procedure are narrower than the WDM light band. Thus, the control unit 15 in this case calculates the reference values Vref1 and Vref2 in a range, which includes the entire band of the signal band illustrated in FIG. 2B, based on the obtained reference values V′ref1 and V′ref2 according to the characteristics of the tunable filter 13. The reference values Vref1 and Vref2 may be calculated by multiplication or addition/subtraction of coefficients according to the filter characteristics. The control unit 15 sets the calculated reference values Vref1 and Vref2 as a drive voltage with which the drive of the tunable filter 13 is started and ended, respectively.

The above-described embodiment discloses an example illustrating that both the reference value Vref1 with which the drive of the tunable filter 13 is started and the reference value Vref2 with which the drive of the tunable filter 13 is ended. Based on the view point of the accuracy of the drive voltage corresponding to the transmission wavelength of the tunable filter 13, both the reference values Vref1 and Vref2 are preferably obtained. However, it is not desired to obtain both the reference values Vref1 and Vref2 most of the time if not always. That is, when a voltage range (a voltage difference between the start voltage and the end voltage) for sweeping the drive voltage is obtained according to the characteristics of the tunable filter 13, either the reference value Vref1 or the reference value Vref2 may appropriately calculated simply by obtaining either of the reference values thereof.

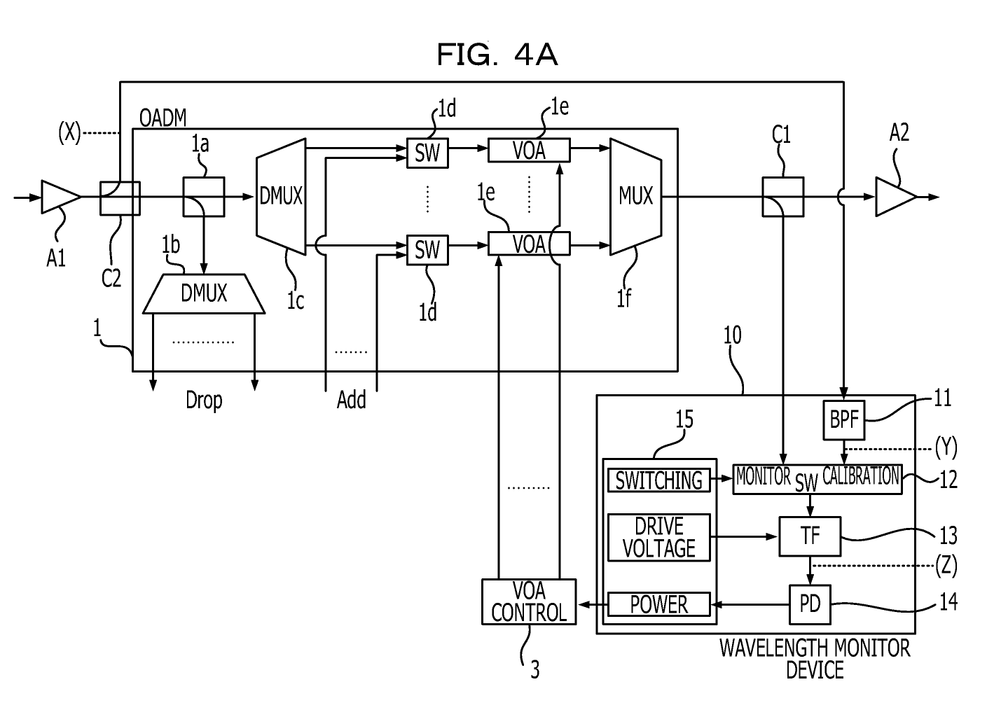

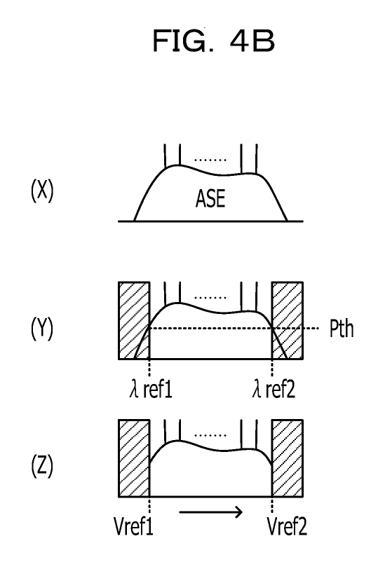

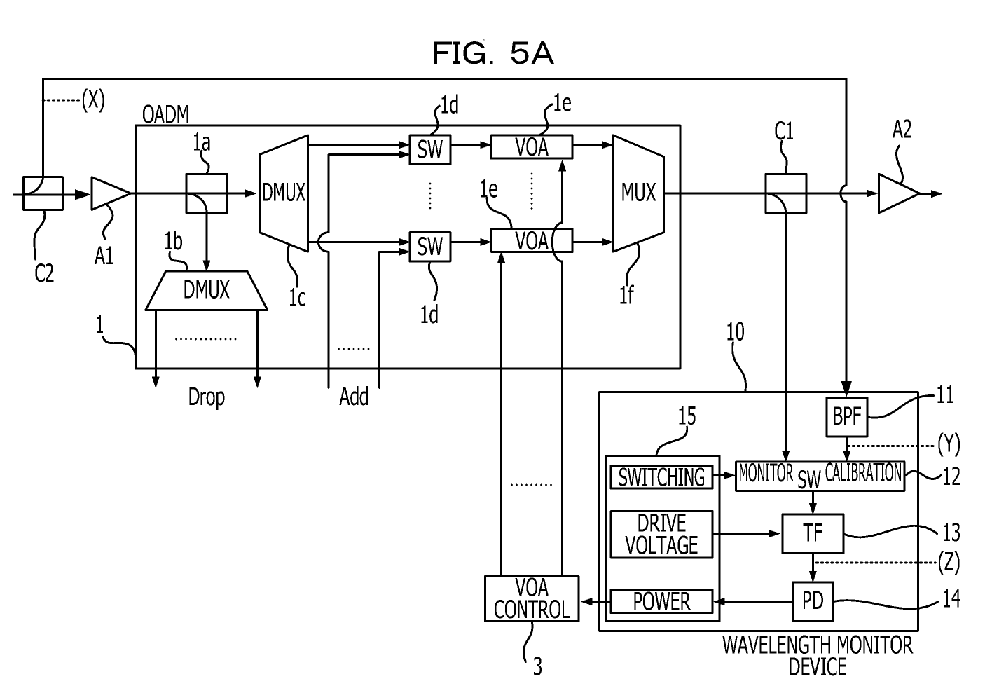

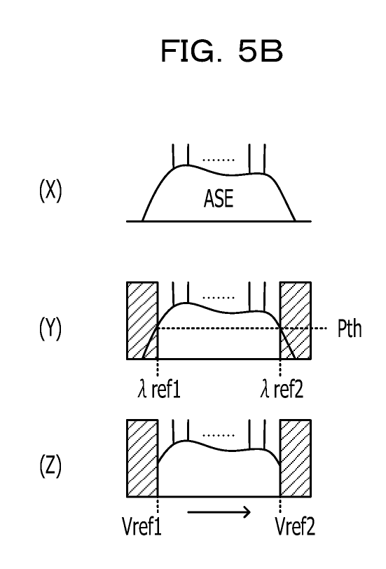

FIGS. 4A and 4B illustrates a second embodiment of the optical monitor device 10. FIGS. 5A and 5B illustrates a third embodiment of the optical monitor device 10. In the second and third embodiments, the position where the WDM light to be input into the band pass filter 11 is branched is changed. The second and third embodiments are similar to the first embodiments excluding the change.

According to the second embodiment illustrated in FIG. 4A, in the optical transmission path, the optical branching device C2, which branches the WDM light with the ASE light to the band pass filter 11, is located in a position where the output light from the optical amplifier A1 provided in front of the OADM 1 as a preamplifier is branched. According to the third embodiment illustrated in FIG. 5A, in the optical transmission path, the optical branching device C2 is located in a position where the input light to be transmitted to the optical amplifier A1 is branched. As illustrated in FIGS. 4B and 5B, if the ASE light generated and accumulated by the optical amplifier provided in a node in an upstream side is included in the WDM light even when the WDM light is taken out in an input side of the OADM 1, calibration using the reference light may be performed by the band pass filter 11 in the similar way as in the first embodiment. As described above, the optical monitor device according to the first, second, and third embodiments does not typically include the temperature sensor and/or the temperature control circuit for calibration of the reference value of the drive signal, and is applicable to the aged deterioration. The band pass filter used in the present embodiment is more inexpensive compared to a case where the temperature sensor and/or the temperature control circuit is embedded in the tunable filter. Therefore, according to the optical monitor device in the first, second, and third embodiments, an optical monitor device, which may compensate the temperature dependence and/or the aged deterioration of the tunable filter, may be realized at low cost.

According the above-described embodiments, a tunable filter that varies a wavelength according to a level of the drive voltage is given as an example. For example, the tunable filter may vary a transmission wavelength by mechanically moving, by an actuator or the like, a thin film whose transmission characteristics differ according to a position where a light is input and in combination with the described embodiments. However, in addition to the tunable filter with a drive voltage as a parameter (that is, a drive signal) of wavelength variation, various tunable filters such as an Acousto Optic Tunable Filter (AOTF) with a drive frequency as a parameter of wavelength variation are applicable to the present application.

According to an aspect of the embodiments of the invention, any combinations of one or more of the described features, functions, operations, and/or benefits can be provided. A combination can be one or a plurality. The embodiments can be provided in an apparatus (a machine) that includes computing hardware (i.e., computing apparatus), such as (in a non-limiting example) any computer that can store, retrieve, process and/or output data and/or communicate (network) with other computers. The control unit 15 can include or be capable of communication with computing hardware, and according to an aspect of an embodiment, described features, functions, calculations, operations, and/or benefits of the monitoring device 10, control unit 15, etc., can be implemented by and/or use optical transmission hardware, computing hardware and/or software executed by computing hardware. In case of computing hardware, a controller (CPU) (e.g., a hardware logic circuitry based computer processor that processes or executes instructions, namely software/program), computer readable media, transmission communication interface (network interface), and/or an output device, for example, a display device, all in communication through a data communication bus could be provided. In addition, an apparatus can include one or more apparatuses in computer network communication with each other or other apparatuses. In addition, a computer processor can include one or more computer processors in one or more apparatuses or any combinations of one or more computer processors and/or apparatuses. An aspect of an embodiment relates to causing or enabling one or more apparatuses and/or computer processors to execute the described operations. The results produced can be output to an output device, for example, displayed on the display.

The values or data used by the monitor device 10, control unit 15, etc. can be stored in a computer-readable media, e.g., a non-transitory or persistent computer-readable medium. Examples of the non-transitory computer-readable media include a magnetic recording apparatus, an optical disk, a magneto-optical disk, and/or semiconductor memory (for example, RAM, ROM, etc.).

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has (have) been described in detail, it should be understood that the various changes, substitutions, and alterations could be made hereto without departing from the spirit and scope of the invention.

What is claimed is:

1. An optical monitor device comprising:
a band pass filter configured to transmit a light of a band of a first input light,
an optical switch configured to select between a second input light and the first input light transmitted through the band pass filter based on a switch signal, and output the selected light,
a tunable filter configured to input a selected light from the optical switch and to transmit a specified wavelength based on a drive signal,
a photodetector configured to output an electric signal according to a power level of a transmitted light from the tunable filter, and
a control unit configured to output the switch signal and the drive signal based on the electric signal.

2. The optical monitor device according to claim 1,
wherein the control unit being configured to;
output the switching signal to switch the optical switch to select the first input light transmitted through the band pass filter,
vary the drive signal,
store, as a reference value, a value of the drive signal obtained when an output value of the photodetector becomes equal to or greater than a threshold value or a value of the drive signal obtained when an output value of the photodetector becomes equal to or smaller than the threshold value,
switch the optical switch to select the second input light, and
set a value of the drive signal obtained when a drive of the tunable filter is started, based on the reference value.

3. The optical monitor device according to claim 2, wherein the control unit calculates, based on the reference value, the value of the drive signal obtained when the drive of the tunable filter is ended.

4. An optical monitor device comprising:
a band pass filter which transmits a light of a band of a first input light,
an optical switch which switches between the first input light transmitted through the band pass filter and a second input light,
a tunable filter which transmits a wavelength, as switched to light of the optical switch, according to a drive signal,
a photodetector which outputs an electric signal according to a power level of a transmitted light through the tunable filter is input, and
a control unit which outputs a signal for controlling switching of the optical switch after an output of the photodetector is input to the control unit,
wherein the control unit switches the optical switch to a side where the first input light transmitting through the band pass filter is output, varies the drive signal, stores an output value of the drive signal, which is obtained when an output value of the photodetector becomes equal to or greater than a prescribed threshold value, as a first reference value, stores an output value of the drive signal, which is obtained when an output of the photodetector becomes equal to or smaller than the threshold value, as a second reference value, switches the optical switch to a side where the second input light is output, sets an output value of the drive signal obtained when drive of the tunable filter is started based on the first reference value, and sets an output value of the drive signal obtained when the drive of the tunable filter is ended based on the second reference value.

5. The optical monitor device according to claim 4, wherein the first input light is a light output by an optical amplifier,
wherein the second input light is a wavelength multiplexed light, and wherein a transmission band of the band pass filter is narrower than a band of an amplified spontaneous emission light included in the first input light, and is wider than the band of the second input light.

6. The optical monitor device according to claim 1, wherein the first input light is a light output by an optical amplifier,
wherein the second input light is a wavelength multiplexed light, and
wherein a transmission band of the band pass filter is narrower than a band of an amplified spontaneous emission light included in the first input light and is narrower than the band of the second input light.

7. The optical monitor device according to claim 1, wherein the first input light is a light output by an optical amplifier as a preamplifier to an optical-add-drop multiplexer,
wherein the second input light is a wavelength multiplexed light, and
wherein a transmission band of the band pass filter is narrower than a band of an amplified spontaneous emission light included in the first input light and is narrower than the band of the second input light.

8. The optical monitor device according to claim 3, wherein the first input light is a light output by an optical amplifier as a preamplifier to an optical-add-drop multiplexer,
wherein the second input light is a wavelength multiplexed light, and
wherein a transmission band of the band pass filter is narrower than a band of an amplified spontaneous emission light included in the first input light and is narrower than the band of the second input light.

9. The optical monitor device according to claim 1, wherein the first input light is a light to be input to an optical amplifier as a preamplifier to an optical-add-drop multiplexer,
wherein the second input light is a wavelength multiplexed light, and
wherein a transmission band of the band pass filter is narrower than a band of an amplified spontaneous emission light included in the first input light and is narrower than the band of the second input light.

10. The optical monitor device according to claim 3, wherein the first input light is a light to be input to an optical amplifier as a preamplifier to an optical-add-drop multiplexer,
wherein the second input light is a wavelength multiplexed light, and
wherein a transmission band of the band pass filter is narrower than a band of an amplified spontaneous emission light included in the first input light and is narrower than the band of the second input light.

11. The optical monitor device according to claim 1, wherein the first input light is a light output by an optical amplifier,
wherein the second input light is a wavelength multiplexed light, and
wherein a transmission band of the band pass filter is narrower than a band of an amplified spontaneous emission light included in the first input light, and is narrower than the band of the second input light.
